(19) United States
(12) Patent Application Publication
(10) Pub. No.: US 2025/0229815 A1
(43) Pub. Date: Jul. 17, 2025

(54) MOBILE RAILWAY ASSET MONITORING APPARATUS AND METHODS

(71) Applicant: Amsted Rail Company, Inc., Chicago, IL (US)

(72) Inventors: Todd Snyder, Newtown Square, PA (US); David Heagerty, Glen Mills, PA (US)

(21) Appl. No.: 19/029,084

(22) Filed: Jan. 17, 2025

Related U.S. Application Data
(60) Provisional application No. 63/621,752, filed on Jan. 17, 2024.

(51) Int. Cl. B61L 25/02; H04W 4/02

(52) U.S. Cl. CPC B61L 25/026; H04W 4/026; B61L 2205/04

(57) ABSTRACT

In one aspect, a mobile railway asset monitoring apparatus is provided that includes a magnetometer and a processor. The magnetometer is configured to detect a magnetic field produced by the earth and influenced by components of the mobile railway asset. The magnetometer is operable to detect a change in the magnetic field caused by relative movement of the components of the mobile railway asset. The processor is operatively connected to the magnetometer and configured to determine a parameter of the mobile railway asset based at least in part upon the change in the magnetic field caused by the relative movement of the components.

### CROSS-REFERENCE TO RELATED APPLICATION

This application claims the benefit of U.S. Provisional Application No. 63/621,752 filed Jan. 17, 2024, which is incorporated herein by reference in its entirety.

### TECHNICAL FIELD

The disclosure relates generally to monitoring mobile railway assets, and more particularly, to monitoring relative movement of components of mobile railway assets.

### BACKGROUND

Existing systems for monitoring the status of mobile railway assets include, for example, stationary monitoring systems and mobile monitoring systems (railcar-based or train-based). Mobile railway assets may include, for example, locomotives, railcars, containers, and/or rail maintenance equipment. Knowing the state of various aspects of the mobile railway asset or components thereof may be useful for remotely tracking the mobile railway asset including, for example, whether the mobile railway asset is in motion or stationary, whether the mobile railway asset is loaded or unloaded, the state of a hatch of a railcar (e.g., opened or closed), a state of a hand brake of the railcar, etc. In existing approaches, the relative movement of components of a railcar is detected with sensors tailored to a specific component. For example, the load status of a freight car may be measured using a specific strain gauge arrangement designed to be applied to a specific load bearing component on the freight car. As another example, a sensor to detect movement of a hand brake of the railcar may utilize a sensor with a mounting bracket that fits to the particular hand brake of the railcar. However, providing a sensor to detect movement of the hand brakes for many different types of railcars may be difficult due to the railcars having different brands, models, and vintages of hand brakes. Moreover, in existing approaches, the sensors used to detect the relative movement of one component of the railcar may not be able to be used to easily detect movement of other components of the railcar. For example, a sensor to detect movement of a hatch of the railcar may not be able to be used to detect movement of the hand brake.

### BRIEF DESCRIPTION OF DRAWINGS

FIG. 1 is a side elevational view of a railcar having mobile railway asset monitoring apparatuses mounted on bolsters of bogies of the railcar;

FIG. 2A is a perspective view of one of the bogies of FIG. 1, FIG. 2A showing one of the mobile railway asset monitoring apparatuses secured to the bolster of the bogie;

FIG. 2B is a schematic view of the mobile railway asset monitoring apparatus of FIG. 2A;

FIG. 3A is a perspective view of the bogie of FIG. 2A and showing a representation of earth's magnetic field near the mobile railway asset monitoring apparatus when the railcar is unloaded and the bolster is a first distance from a side frame of the bogie;

FIG. 3B is a view similar to FIG. 3A showing a representation of the earth's magnetic field near the mobile railway asset monitoring apparatus when the railcar is loaded and the bolster is farther from the side frame than when the railcar is loaded;

FIG. 4 is a graph showing a relationship between magnetic field measurements detected by the mobile railway asset monitoring apparatus relative to compression of springs of the bogie of FIG. 2A as the load of the railcar changes;

FIG. 5 is a flow chart of a method for determining a parameter of the railcar using the mobile railway asset monitoring apparatus of FIG. 2A.

FIG. 6 is a graph showing magnetic field measurements detected by the mobile railway asset monitoring apparatus of FIG. 2A as the railcar moves along a section of track in a loaded state and as the railcar moves along the same section of track in the unloaded state; and

FIG. 7 is a perspective view of a magnetic field influencer on a side frame of a bogie and proximate the mobile railway asset monitoring apparatus mounted to a bolster of the bogie.

### DETAILED DESCRIPTION

In one aspect, a mobile railway asset monitoring apparatus is provided that includes a magnetometer and a processor. The mobile railway asset monitoring apparatus is configured to be fixed to a mobile railway asset. The magnetometer is configured to detect a magnetic field produced by the earth and influenced by components of the mobile railway asset. The magnetometer is operable to detect a change in the magnetic field caused by relative movement of the components of the mobile railway asset. The processor is operatively connected to the magnetometer and configured to determine a parameter of the mobile railway asset based at least in part upon the change in the magnetic field caused by the relative movement of the components. As one example, the magnetometer is operable to detect a change in the magnetic field caused by relative movement of a side frame of a bogie of the mobile railway asset relative to a bolster of the bogie. The parameter includes a load state (e.g., loaded, unloaded, a weight of the load, etc.) and the processor determines the load state of the mobile railway asset based at least in part on the change in the magnetic field caused by the relative movement of the side frame relative to the bogie caused by a change in the load state of the mobile railway asset.

In another aspect, a mobile railway asset monitoring apparatus is provided that includes a proximity sensor and a processor. The proximity sensor is configured to detect relative movement of components of a mobile railway asset. The proximity sensor may be, as examples, a magnetometer, a capacitance sensor, an ultrasonic sensor, a light sensor, a radar sensor, and/or a LiDAR sensor. The processor is operatively connected to the proximity sensor and is configured to receive data indicative of whether the mobile railway asset is stationary. As examples, the processor may detect the mobile railway asset is stationary based on data of the proximity sensor (e.g., the data does not vary significantly over a time period) and/or based on data of a movement sensor (e.g., GNSS circuitry, an accelerometer, gyroscope, etc.). The processor is configured to determine a parameter of the mobile railway asset based at least in part upon the mobile railway asset being stationary and the relative movement of the components of the stationary mobile railway asset. When the mobile railway asset is not stationary, the relative movement of the components may be caused by movement of the mobile railway asset along the track (e.g., rocking or bouncing) which may reduce the accuracy of the parameter being determined (e.g., load state). Moreover, movement of the mobile railway asset may produce noise in the data from the proximity sensor that makes it more difficult for the processor to calculate the parameter of the mobile railway asset. Thus, the accuracy of the determination of the parameter is improved by making the determination of the parameter when the mobile railway asset is stationary.

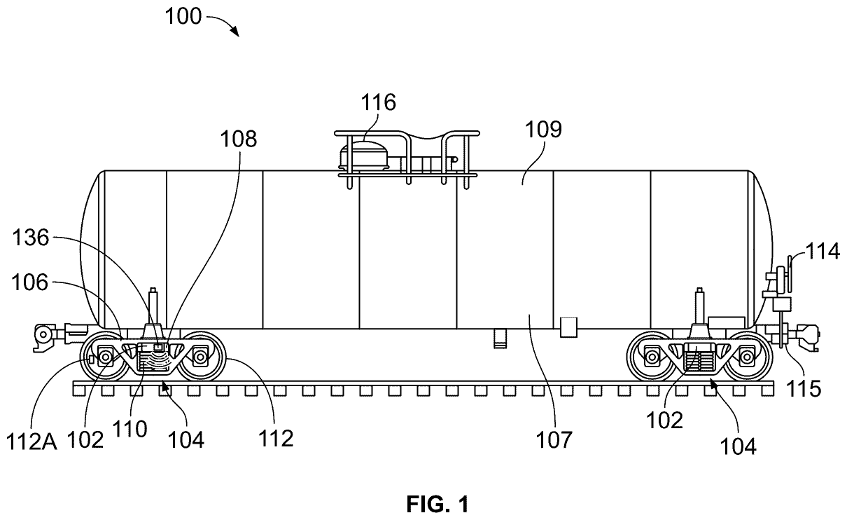

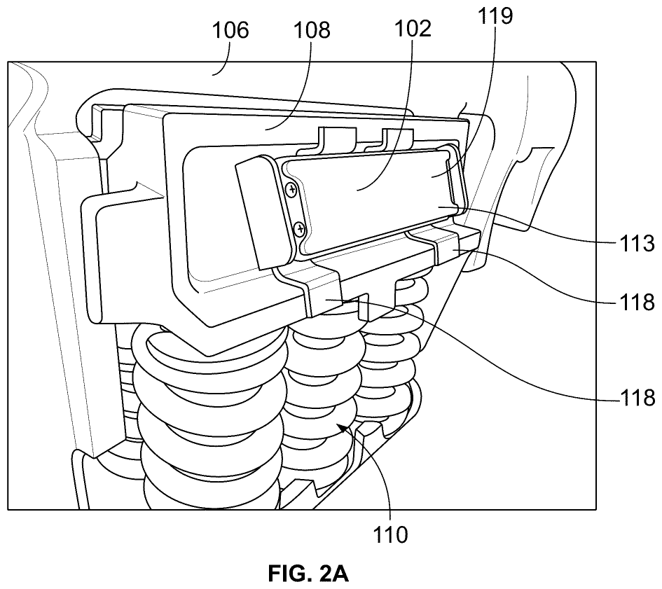

With reference to FIG. 1, a mobile railway asset such as a railcar 100 is provided that includes mobile railway asset monitoring apparatuses 102. The railcar 100 includes two trucks or bogies 104 that each include side frames 106 and a bolster 108. The bogies 104 may, for example, be standard 3-piece trucks typical of railcars in the United States. Each end of the bolster 108 rests on a spring pack 110 (see also FIG. 2A) that connects the bolster 108 to the side frames 106 of the bogie 104. The side frames 106 of each bogie of the railcar 100 are connected to two wheelsets 112. Each wheelset 112 may be an assembly including two wheels rigidly connected by an axle and two bearings to rotatably couple the axle to the side frames 106. The railcar 100 includes a hand brake system having a hand brake wheel 114 on an end of the railcar 100 connected to a bell crank 115 with a chain. The bell crank 115 is connected to a brake beam with another chain or linkage to cause the brake beam to pull against at least one of the wheels of the wheel sets 112 as the hand brake wheel 114 is rotated and the bell crank 115 pivots. The railcar 100 may be a tank car having a tank 109 with a loading hatch cover 116 that may be moved between an open position and a closed position.

With reference to FIG. 2A, the mobile railway asset monitoring apparatus 102 is shown mounted to the bolster 108 of the railcar 100. The mobile railway asset monitoring apparatus 102 may be similar in many respects to the mobile railway asset monitoring apparatuses disclosed in U.S. patent application Ser. No. 17/945,052, filed Sep. 14, 2022, which published as U.S. Patent Publication No. 2023/0083294 on Mar. 16, 2023, which is hereby incorporated by reference herein in its entirety. The mobile railway asset monitoring apparatus 102 has a body 113 that includes a mounting bracket 118 and a housing 119. The housing 119 contains some or all of the electrical components of the mobile railway asset monitoring apparatus 102. The housing 119 may form a sealed compartment for the electrical components that resists the ingress of water and debris. The mounting bracket 118 is configured to support the mobile railway asset monitoring apparatus 102 on the bolster 108 and may be secured to the bolster 108 via welds and/or fasteners as some examples.

With reference to FIG. 2B, the mobile railway asset monitoring apparatus 102 includes a processor 120, memory 122, communication circuitry 124, a power source 126, and a plurality of sensors 127. The processor 120 is in communication with memory 122. The processor 120 may execute programs and functions stored in the memory 122 to control operations of the mobile railway asset monitoring apparatus 102, such as the operations discussed below. The processor 120 may include, as examples, a microprocessor, an application-specific integrated circuit (ASIC), or a field programmable gate array (FPGA). The memory 122 may include, as examples, an electrical charge-based storage media such as EEPROM or RAM, ROM, or other non-transitory computer readable media such as a flash memory device or magnetic or optical storage medium. The processor 120 and memory 122 are shown schematically as separate components, but it will be appreciated that various embodiments of the processor 120 may include the memory 122 to facilitate the processor 120 performing operations as discussed herein. For example, the processor 120 may include an integrated circuit board having one or more microprocessors and one or memory devices such as RAM and/or ROM. The one or more memory devices store software (e.g., computer code) that, when executed by the one or more microprocessors, perform operations as set forth herein.

The communication circuitry 124 is configured to wirelessly communicate with one or more remote computers 125. As examples, the communication circuitry 124 may be configured to communicate directly with remote computers using short-range communication protocols such as Bluetooth®, WiFi, Zigbee, Z-wave, infrared, etc. The communication circuitry 124 may communicate indirectly with remote computers using long-range communication protocols such as cellular (e.g., 3G, 4G, 5G), LAN, WiMAX, and/or LoRaWAN as some examples. The processor 120 may use the communication circuitry 124 to communicate with remote devices via a network, such as a cellular network and/or the internet. The processor 120 may communicate with a remote computer 125, such as a computer of a cloud computing system or a computer of a locomotive associated with the railcar 100. For example, the processor 120 may communicate data (e.g., sensor data, railcar parameter data) to the remote computer 125 via the communication circuitry 124 for processing and/or storage. For conciseness, the processor 120 of the mobile railway asset monitoring apparatus 102 is described herein as processing the sensor data to determine parameters of the railcar 100, however, is should be understood that such processing could be done by the processor 120, a processor 131 of the remote computer 125, or a combination (e.g., some processing is done at the processor 120 and other processing steps are done at the processor 131). In other words, the processor described herein may encompass a processor onboard the mobile railway asset monitoring apparatus 102, a processor offboard the mobile railway asset monitoring apparatus 102 such as a processor of a cloud computing system, or a combination of onboard and offboard processors.

In one embodiment, the processor 120 provides initial data processing, control of onboard devices, and controls the communication circuitry 124 to communicate with the remote computer 125. The remote computer 125 receives data from one or more mobile railway asset monitoring apparatuses 102 of the railcar 100 and performs higher level processing, such as determining one or more parameters of the railcar 100, by applying heuristics to the data and drawing conclusions based on the analysis. Further, memory 129 of the remote computer 125 may store historical data from the mobile railway asset apparatuses 102 of the railcar 100 and other mobile railway assets that are used to determine the one or more parameters of the railcar 100.

The power source 126 of the mobile railway asset monitoring apparatus 102 may include a battery and/or an energy harvesting device. The power source 126 provides electrical power to the electrical components of the mobile railway asset monitoring apparatus 102, for example, to power the processor 120, the communication circuitry 124, and the sensors 127. The energy harvesting device may harvest energy from the environment and convert the energy to electrical power to power the electrical components and/or charge the battery. As an example, the energy harvesting device may include a solar panel on an exterior of the housing 119. As another example, the energy harvesting device may generate electrical power from movement of the railcar, wind, and/or a temperature differential.

Regarding FIG. 2B, the mobile railway asset monitoring apparatus 102 includes one or more sensors 127 to collect data at the railcar 100 and to determine one or more parameters of the railcar based on the sensor data. The mobile railway asset monitoring apparatus 102 may include a movement sensor to detect whether the railcar 100 is stationary or in motion (e.g., moving along a track). The movement sensor may include, for example, global navigation satellite system (GNSS) circuitry 128, an accelerometer 130, a magnetometer 132, a microphone 134, an ultrasonic sensor 136, an electromagnetic sensor 138, and/or a gyroscope 141. The processor 120 may use the data of one or more of these sensors to determine whether the railcar 100 is stationary or in motion. The GNSS circuitry 128 is circuitry is configured to receive GNSS data from satellites of one or more GNSS's to determine a location and/or orientation of the mobile railway asset monitoring apparatus 102 on earth. Examples of GNSS include GPS, GLONASS, BeiDou, and Galileo. In one embodiment, the processor 120 may determine the railcar 100 is in motion upon detecting that the location of the railcar 100 is changing. Conversely, the processor 120 may determine that the railcar 100 is stationary where the location of the railcar 100 has not moved for a certain period of time.

In some forms, the processor 120 may additionally or alternatively use the data of the accelerometer 130, the magnetometer 132, the microphone 134, the ultrasonic sensor 136, and/or the electromagnetic sensor 138 to determine if the railcar 100 is moving or stationary. For instance, the processor 120 may use the data from at least two sensors to determine whether the railcar 100 is stationary. For example, the processor 120 may conclude whether the railcar 100 is moving or stationary based on the sensor data of two types of sensors. As another example, the processor 120 may use the data of the second sensor to corroborate or increase the confidence in the determination of whether the railcar 100 is moving or stationary based on data of the first sensor.

Regarding the accelerometer 130 and the gyroscope 141, the processor 120 may analyze the data of the accelerometer 130 and/or the gyroscope 141 to detect vibrations of the railcar 100 indicating the railcar 100 is in motion. Regarding the magnetometer 132, the processor 120 may analyze the data of the magnetometer 132 to detect changes in the earth's magnetic field, for example, changes indicative of a change in the orientation of the railcar 100 (e.g., from north to east) and/or changes caused by the railcar 100 bouncing or rocking as the railcar moves along a track. Regarding the microphone 134, the processor 120 may analyze data of the microphone 134 to detect vibrations and noises caused by the railcar 100 when in motion, for example, vibration noise from a bearing of the wheelset 112, noise from the wheelset 112 rolling along a track, etc. Regarding the ultrasonic sensor 136 and the electromagnetic sensor 138, these sensors may be used to measure the distance between the sensor and another component. For example, these sensors could be used to measure the distance between a body 107 (see FIG. 1) of the railcar 100 and the ground or track below the railcar 100 which may, for example, vary cyclically as the railcar 100 moves along the track and may be static when the railcar 100 is stationary.

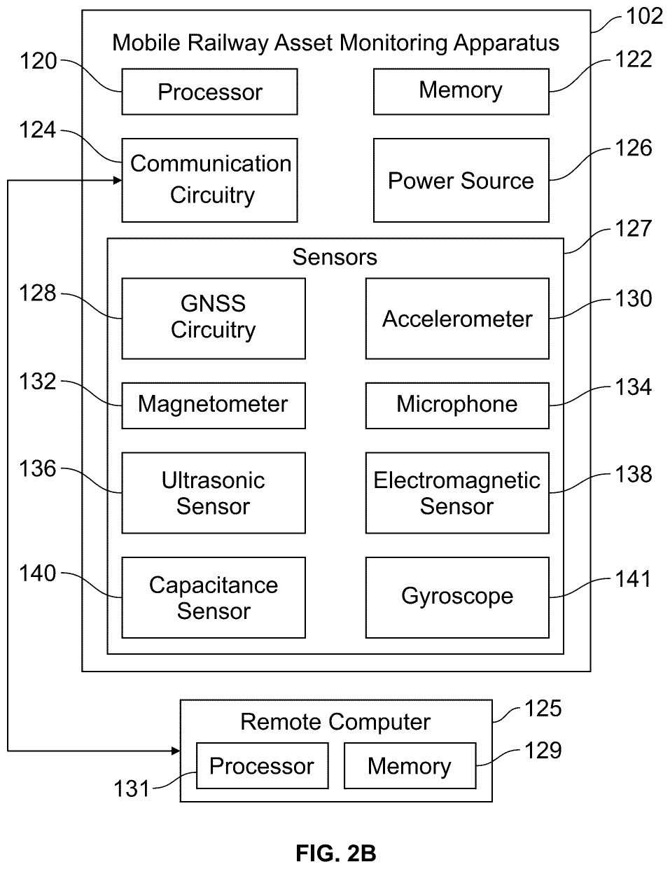

The mobile railway asset monitoring apparatus 102 may include a proximity sensor to detect the relative movement of components of the railcar 100. For example, as discussed below with respect to FIGS. 3A-3B, the proximity sensor may detect the relative movement of the side frame 106 of the bogie 104 relative to the bolster 108. In other embodiments, the mobile railway asset monitoring apparatus 102 may be mounted proximate other components of the railcar to be monitored, for example, at the bell crank 115 or hatch cover 116. For instance, where the proximity sensor is proximate the bell crank 115, the proximity sensor may detect relative movement of the bell crank 115 relative to another component of the railcar 100 to detect when the hand brake is being set or released. Similarly, where the proximity sensor is proximate the hatch cover 116, the proximity sensor may detect relative movement of the hatch cover 116 relative to the body of the tank 109 to detect when the hatch cover 116 is being open or closed.

The proximity sensor may include, as examples, the magnetometer 132, the ultrasonic sensor 136, the electromagnetic sensor 138 (e.g., a radar sensor, a LiDAR sensor), and/or the capacitance sensor 140. The processor 120 may detect relative movement of components of the railcar 100 using one or more types of proximity sensors. For example, the processor 120 may use the sensor data of two types of proximity sensors to detect the relative movement of components of the railcar 100. For example, the processor 120 may use data of the second sensor to corroborate or increase the confidence in a determination based on the first sensor.

The magnetometer 132 may be a one-axis, two-axis, or three-axis magnetometer. The magnetometer 132 is configured to detect a magnetic field produced by the earth and influenced by the components of the railcar 100. For example, the magnetometer 132 may be a compass configured to detect the orientation of the mobile railway asset monitoring apparatus 102 and/or the railcar 100 relative to the earth. The processor 120 may calibrate the magnetometer 132 once the mobile railway asset monitoring apparatus 102 installed on the railcar 100, for example, to account for the influence of magnetic material and/or ferrous material in the surrounding environment that affects the magnetic field detected by the magnetometer.

For example, the processor 120 may calculate one or more soft iron offsets for the magnetometer 132 to compensate for ferrous material of the railcar 100 that influences the magnetic field generated by the earth and detected by the magnetometer 132. Alternatively or additionally, the processor 120 may calculate one or more hard iron offsets for the magnetometer to compensate for magnetic material of the railcar 100 that influences the magnetic field generated by the earth and detected by the magnetometer 132.

The processor 120 may be configured to calibrate the magnetometer (e.g., calculate the soft iron offsets and/or hard iron offsets) over time, for example, by collecting data as the railcar 100 is in motion and changes orientation. The processor 120 may be configured to calibrate the magnetometer (e.g., calculate the soft iron offsets and/or hard iron offsets) by calculating soft iron offsets using the location and/or orientation of the mobile railway asset monitoring apparatus 102 and/or railcar 100. For example, the processor 120 may use the data of the GNSS circuitry 128 to determine the location and direction of travel or heading of the railcar 100 and use the location and heading data to calculate soft and/or hard iron offsets based in part upon the magnitude and direction of the magnetic field detected by the magnetometer 132.

The processor 120 may calculate different soft and/or hard iron offsets for the magnetometer 132 at different times. For example, the processor 120 may calculate and use one set of soft and hard iron offsets when the railcar 100 is in a first state and another set of soft and hard iron offsets when the railcar 100 is in a second state. As one example, the first state is when the railcar 100 is loaded and the second state is when the railcar 100 is empty or unloaded. As another example, the first state is when the railcar is in a train adjacent to railcars loaded with grain and the second state is when the railcar is in a train adjacent to railcars loaded with iron ore.

The magnetometer 132 is able to detect the magnetic field produced by the earth and which is influenced by components of the railcar 100. For example, many components of the railcar are formed of a ferrous material (e.g., iron, steel) which affects the direction and/or magnitude of the magnetic field generated by the earth as the magnetic field flows about the components. With the magnetometer 132 proximate such a ferrous component, the magnetic field produced by the earth and detected by the magnetometer changes as the ferrous component moves relative to the magnetometer 132. The processor 120 may determine the proximity of the ferrous component to the magnetometer 132 based at least in part on the detected magnetic field. For example, the processor 120 may determine the position of the ferrous component by comparing the detected magnetic field data to historical magnetic field data associated with one or more positions of the ferrous component. For example, where the current magnetic field data closely corresponds to historical data of the ferrous component in a certain position, the processor 120 may conclude the ferromagnetic material is currently at that position.

The processor 120 may also detect when the mobile railway asset monitoring apparatus 102 has been removed from the railcar 100, for example, due to significant and unexpected changes in the magnetic field not attributable to normal magnetic field behavior when the mobile railway asset monitoring apparatus 102 is mounted to the railcar 100. The mobile railway asset monitoring apparatus 102 may thereby be able to detect when the mobile railway asset monitoring apparatus 102 is being tampered with, for example, when a vandal removes the mobile railway asset monitoring apparatus 102 from the railcar 100.

Regarding the ultrasonic sensor 136 and electromagnetic sensor 138, these sensors are oriented to emit sound waves or electromagnetic radiation toward a monitored component or object (e.g., the ground) and to detect the distance to the monitored component or object based on the reflected sound waves or electromagnetic radiation. For embodiments where the object includes the ground, the ground may include railroad ties, one or more of the rails, and/or an area next to the track. Regarding the capacitance sensor 140, this sensor detects a change in capacitance caused by the proximity of a component or object to the sensor 140.

With reference to FIG. 3A-3B, the mobile railway asset monitoring apparatus 102 is secured to the bolster 108 to detect movement of the side frame 106 of the bogie 104 relative to the bolster 108. The bolster 108 of the bogie 104 is supported by the spring pack 110 such that the bolster 108 may move downward, away from the side frame 106 as the spring pack 110 is compressed and upward, toward the side frame 106 as the spring pack 110 expands. As the railcar 100 is loaded, the weight of the load on the bolster 108 compresses the spring pack 110 causing the bolster 108 to move downward away from the side frame 106 in direction 143 as shown in FIG. 3B. As the railcar 100 is unloaded, and the weight of the load on the bolster 108 decreases, the spring pack 110 expands urging the bolster 108 upward toward the side frame 106 in direction 145 as shown in FIG. 3A. The side frame 106 and bolster 108 are formed of ferrous material such as steel that disrupts the earth's magnetic field (e.g., changes the direction and/or magnitude of the magnetic field) about the bogie 104. The body 107 of the railcar 100, such as the tank 109, may likewise be formed of a ferrous material and also disrupts the earth's magnetic field about the bogie 104.

For illustration, magnetic field lines 144, 146 of the magnetic field produced by the earth are shown on FIGS. 3A-3B to illustrate a change in the state of the magnetic field about the bogie 104 as the side frame 106 and tank 109 move relative to the bolster 108. For instance, as the side frame 106 moves toward or away from the bolster 108, the size of a gap 147 between the side frame 106 and the bolster 108 changes, which affects the direction and/or magnitude of the magnetic field line 144 passing through the gap 147 as the influence of the side frame 106 on the magnetic field line 144 changes. And, similarly, movement of the side frame 106 affects the direction and/or magnitude of the magnetic field line 146 going over the side frame 106 as the side frame 106 moves relative to the magnetic field. With the mobile railway asset monitoring apparatus 102 mounted on the bolster 108 and proximate the side frame 106, the magnetometer 132 detects changes in the magnetic field caused by the relative movement of the side frame 106 and bolster 108. As illustrated, the magnetic field detected by the magnetometer 132 has a first state 148 (see FIG. 3A) when the railcar 100 is unloaded and a second state 150 (see FIG. 3B) when the railcar 100 is loaded due to the influence of the side frame 106 on the magnetic field. As used herein, the term relative movement of components encompasses different types of movement, such as movement of one component toward or away from a stationary component, movement of two (or more) components toward or away from each other, etc. The term relative movement of components also encompasses linear movement and/or rotational movement of components relative to one another.

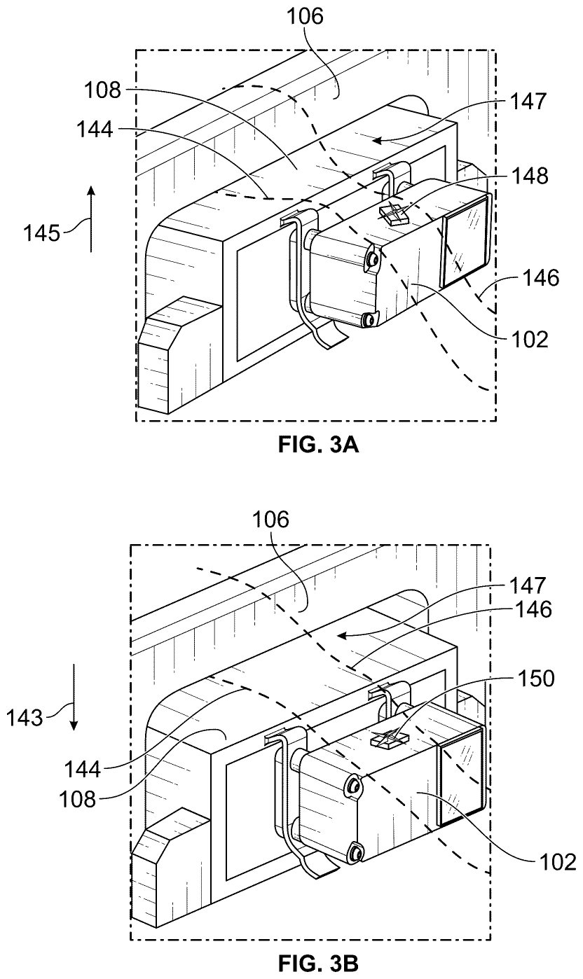

With reference to FIG. 4, a graph 152 is shown illustrating example data points of magnetic field variation detected by the magnetometer 132 at various spring pack 110 compression distances. The spring pack 110 compression distance is the distance the spring pack 110 is compressed from a state where the railcar 100 is fully unloaded, which correlates to the distance of the gap 147 between the side frame 106 and the bolster 108 causing a change in the magnetic field as discussed above. The magnetic field variance may be a value derived from magnetic field measurements of the magnetometer (e.g., in one or more axes), for example, a value calculated by the processor 120. As an example, the magnetic field variance may be calculated by squaring the change in each of the X- and Y-axis magnetometer data and adding the squared values.

As indicated by the line 154, in this example, there is a linear correlation between the magnetic field variance and the spring compression distance. The processor 120 may thereby use the data of the magnetic field variance derived from magnetic field measurement data of the magnetometer 132 to determine the spring compression distance of the railcar 100, which may be indicative of a load state of the railcar 100. For example, the processor 120 may utilize a machine learning model trained with data from similar bolster installations to determine a current spring compression distance based upon a detected magnetic field measurement.

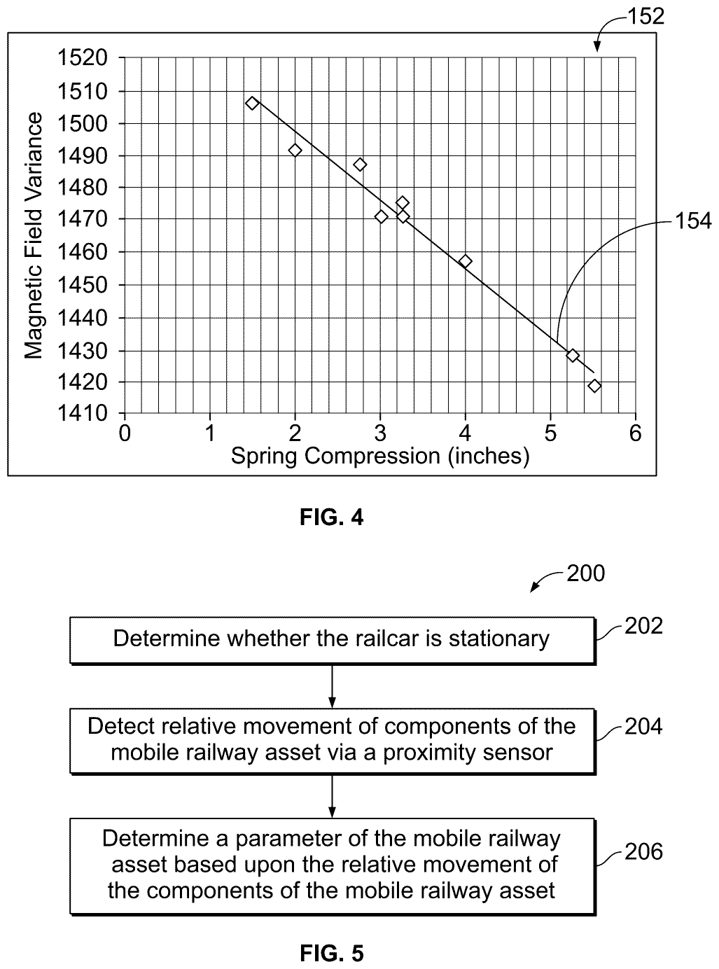

With respect to FIG. 5, the processor 120 may use method 200 to determine a parameter of the railcar 100 based at least in part on detection of relative movement of components of the railcar 100. As noted above, the following discussion refers to processor 120 but the method 200 may alternatively be performed by processor 131 of the remote computer 125 or a combination of the processors 120, 131.

The processor 120 may determine 202 whether the railcar 100 is stationary or moving. The processor 120 may determine the railcar 100 is stationary based upon instantaneous or historical data of one or more of the sensors 127 of the mobile railway asset monitoring apparatus 102, for example, the GNSS circuitry 128, the accelerometer 130, the magnetometer 132, the microphone 134, the ultrasonic sensor 136, the electromagnetic sensor 138, and/or the gyroscope 141. The processor 120 may use a combination of multiple sensors (e.g., magnetometer, GNSS circuitry, accelerometer, microphone, etc.) to interpret the sensor data and infer the railcar's present state of motion based on the data (e.g., the data indicates the railcar 100 is stationary, moving, another train is passing by, etc.). The processor 120 utilizes software that may identify trends in sensor data and has other stored information (e.g., historical data) which can be used to identify whether the railcar 100 is stationary. The processor 120 may use data processing techniques to eliminate or separate externally caused variations in the sensor data (e.g., correct for temperature changes, exclude wildly changing measurements such as due to a nearby train, and exclude patterns that are not of interest to determining if railcar is stationary). The processor 120 may use statistical calculations and/or machine learning methods to identify patterns indicating the railcar 100 is stationary and/or to filter out noise in the data. In some forms, the processor 120 may receive information from another source indicating whether the railcar 100 is stationary or moving, for example, information from the remote computer, an associated locomotive, or another sensor of the railcar 100.

Determining when the railcar 100 is stationary or in motion may enable the processor 120 to more accurately and/or more easily determine when relative movement of components of the railcar 100 is due to a change in the parameter of the railcar (e.g., a change in load state) or due to motion of the railcar 100 as it travels along the tracks. For example, movement of the railcar 100 onto a steel bridge and then off of the steel bridge may cause significant changes in the magnetic field detected by the magnetometer 132 that appear similar to a change in load state. Knowing when the railcar 100 is stationary or in motion may aid the processor 120 in interpreting whether changes in the magnetic field are attributable to a change in a parameter of the railcar 100. As another example, while the side frame 106 moves relative to the bolster 108 during a change in load state, the side frame 106 may also move relative to the bolster 108 when the railcar 100 is traveling along a track, for example, due to rocking or bouncing motion of the tank 109. The processor 120 may be configured to detect changes in the parameter of the railcar 100 when the railcar 100 is stationary, for example, where the change in parameter is more likely to caused by a change in a condition of interest of the railcar 100 instead of noise caused by movement of the railcar 100.

The processor 120 detects 204 relative movement of components of the railcar 100 via the proximity sensor. As one example, the processor 120 may use the magnetometer 132 to detect a change in the magnetic field caused by relative movement of the components of the railcar 100, such as the side frame 106 relative to the bolster 108. In other approaches, the processor 120 may similarly use the ultrasonic sensor 136, the electromagnetic sensor 138, and/or the capacitance sensor 140 to detect relative movement of components of the railcar 100, as discussed above.

In some forms, the processor 120 is configured to analyze data indicative of the relative movement of the components of the railcar 100 that is associated with a time period that the railcar 100 is stationary. For example, the processor 120 analyzes the sensor data of the proximity sensor having timestamps that correspond to a time period when the railcar 100 is stationary. The processor 120 may use data processing techniques to eliminate or separate externally caused variations in the sensor data gathered at step 204 (e.g., correct for temperature changes, exclude wildly changing measurements, exclude patterns that are not of interest to determining movement of components of the railcar). The processor 120 may use statistical calculations and/or machine learning methods to identify patterns indicating movement of the side frame 106 due to a change in load state and/or to filter out noise. Where the railcar 100 is determined to be in motion, the processor 120 may filter out data of the proximity sensor gathered when the railcar 100 is in motion, treating it as noise resulting from movement of the railcar 100.

The processor 120 determines 206 a parameter of the railcar 100, such as a load state of the railcar 100, based upon the detected relative movement of components of the railcar 100. For instance, where the proximity sensor (e.g., magnetometer 132) detects relative movement of the side frame 106 relative to the bolster 108, the processor 120 may determine that the load state of the railcar 100 has changed. For example, the processor 120 may detect that the bolster 108 has moved away from the side frame 106 and determine that the railcar 100 has been loaded. Conversely, the processor 120 may detect that the bolster 108 has moved toward the side frame 106 and determine that the railcar has been unloaded. The processor 120 may determine the position of the bolster 108 relative to the side frame 106 (e.g., the distance of the gap 147), for example, by calculating the distance of the gap 147 or the spring compression based upon the current magnetic field data and/or historical data (such as the data represented by graph 152) that correlates the magnetic field data to physical movement. In some forms, the processor 120 may compare the magnetic field data of the magnetometer 132 to a database providing a correlation between magnetic field data and physical movement based on the location (e.g., GPS coordinates) and/or orientation of the railcar 100, a component of the railcar 100, and/or the mobile railway asset monitoring apparatus 102. As the magnitude and direction of the magnetic field produced by the earth varies by location and orientation relative to the earth, such a database may aid to interpret the magnetic field data of the magnetometer 132.

In some approaches, the processor 120 determines the parameter of the railcar 100 based upon the railcar 100 being stationary and the detection of relative movement of components of the railcar 100. The sensor data of the magnetometer 132 may change continuously when the railcar 100 is in motion, for example, due to the bouncing and rocking of the railcar 100, due to the railcar 100 passing magnetic and/or ferrous objects (e.g. steel buildings), and the change in orientation of the railcar 100 relative to the earth's magnetic field as the railcar 100 travels along a track. By determining the parameter of the railcar 100 when the railcar 100 is stationary, the processor 120 makes the determination when the signal-to-noise ratio of the sensor data of the magnetometer 132 is significantly higher and at a time when changes in the parameter of the railcar 100 are more likely to be due to movement associated with the condition of interest, e.g., loading or unloading of the railcar 100. The processor 120 may also be configured to determine when the data of the sensors 127 is caused by a change in a parameter of the railcar 100 or caused by a nearby environmental change when the railcar 100 is stationary, such as when another train or vehicle passes by the railcar 100. For example, the processor 120 may use data processing techniques to identify noise caused by such environmental changes.

In some approaches, the processor 120 determines the parameter of the railcar 100 using software to interpret the sensor data of the proximity sensor. For example, the processor 120 may use machine learning algorithms trained on historical data known to correspond to certain parameters to interpret the sensor data. The processor 120 may also be configured to draw conclusions from the sensor data gathered over a period of time. For example, loading the railcar 100 may take 25 minutes, resulting in a generally gradual movement of the bolster 108 away from the side frame 106 over this time period. Where the sensor data indicates that the bolster 108 is oscillating and moving abruptly, the processor 120 may determine the change in position of the bolster 108 relative to the side frame 106 is not due to a change in load state because oscillating pattern is not consistent with a loading event and/or the position of the bolster 108 relative to the side frame 106 is moving too quickly to be a change in load state. The processor 120 may thereby use the determination of movement of the railcar 100 to identify the data of the time-series set of data from the magnetometer 132 to discard or ignore when determining the parameter of the railcar 100.

In some forms, the processor 120 determines the parameter of the railcar 100 based upon sensor data of the proximity sensor collected at a time when the railcar 100 is moving. While the sensor data may vary due to motion of the railcar 100 along a track, the sensor data of the proximity sensor may have different characteristics based on the parameter of the railcar 104. For example, the sensor data when the railcar 100 is in a loaded state may have different characteristics than when the railcar 100 is in an unloaded state. The processor 120 may determine the state of the railcar 100 based on the characteristics of the sensor data as discussed in further detail below. For example, the processor 120 may determine the parameter of the railcar 100 upon the sensor data corresponding with historical sensor data associated with the loaded state or unloaded state.

A railway asset monitoring apparatus 102 may be mounted on each bogie 104 of the railcar 100, for example, to provide data from each end of the railcar 100. The data from the mobile railway asset monitoring apparatuses 102 may be compared, for example, to determine the load state of the railcar 100. For instance, for a tank car, the load state of the railcar 100 should generally be similar at each end of the tank car and a single mobile railway asset monitoring apparatus 102 may be used on one bogie 104 to determine whether the tank car is unloaded or loaded. Railcars such as covered hoppers, however, may include multiple compartments which may be loaded individually. To detect loading of the hopper car, a railway asset monitoring apparatus 102 may be mounted to each bogie 104 and enable a determination of which compartment is loaded.

Determining the load state of the railcar 100 is useful for analysis of railcar operations and tracking. For example, data pertaining to the load state of the railcar 100 may be useful in providing route classifications and determining when to perform maintenance on the railcar 100. The location of changes in the load state may also be used to identify loading and unloading facilities along a route. The load state may also be used to improve the measurements of other aspects for the railcar 100, for example, in interpreting and using data pertaining to wheel and bearing vibration.

While the above example primarily relates to use of the mobile railway asset monitoring apparatus 102 to determine the load state of the railcar 100, the mobile railway asset monitoring apparatus 102 could similarly be used to determine other parameters of the railcar including: a change in position of a hand brake component (e.g., the bell crank 115); movement of a brake rigging component; movement of the hatch cover 116; movement of a coupler component; movement of a gate component; movement of a valve component; raising of a portion of the mobile railway asset; and tilt of a component of the mobile railway asset. To monitor changes in the parameters of a component of the railcar 100, the mobile railway asset monitoring apparatus 102 is mounted to the railcar 100 proximate such component such that the proximity sensor, such as the magnetometer 132, is able to detect movement of the component as described above with respect to the side frame 106.

The mobile railway asset monitoring apparatus 102 is configured to enable mounting with few installation parameters other than to be in proximity to the component to be monitored. The mobile railway asset monitoring apparatus 102 can be fixed at a variety of positions on the railcar 100 and is not limited by the type of railcar 100 or model of a particular component to be monitored (e.g., a certain hatch cover model). In other words, so long as the mobile railway asset monitoring apparatus 102 is mounted proximate to the component to be monitored, the processor 120 is configured (e.g., using software at the processor 120 and/or processor 131) to interpret the data of the sensors 127 to determine a change in a parameter of the railcar (e.g., based on a movement of a monitored component).

The processor 120 may be configured to determine a parameter of the railcar 100 based on data captured when the railcar is moving. The processor 120 may use different algorithms to process the sensor data of the mobile railway asset monitoring apparatus 102 based on whether the railcar 100 is stationary or moving. Thus, determining whether the railcar 100 is moving or stationary may indicate which algorithm(s) to use to process the sensor data.

The processor 120 may use algorithms to aggregate and process sensor data of the mobile railway asset monitoring apparatus 102 (e.g. sensor data of one or more sensors 127) when the railcar 100 is moving to produce a set of data characteristics of the state of the railcar 100, such as a loaded state or unloaded state. The processor 120 may compare data characteristics of data collected at a first time when the railcar 100 is moving with data characteristics of data collected at a second time when the railcar 100 is moving. Where the data characteristics of the first time differ from the data characteristics of the second time, the processor 120 may determine that the state of the railcar 100 at the first time is different than the state of the railcar 100 at the second time. Conversely, where the data characteristics of the first time are similar to the data characteristics of the second time, the processor 120 may determine that the state of the railcar 100 is the same at both periods of time. The processor 120 may associate a first set of data characteristics with a first state (e.g., the loaded state) and a second set of data characteristics with a second state (e.g., the unloaded state). The processor 120 may compare sensor data when the railcar 100 is moving with the first set of data characteristics and the second set of data characteristics to identify the state of the railcar 100. For example, the processor 120 may compare data characteristics before and after the railcar 100 stops to unload. Differences in the data characteristics indicate that the railcar 100 has been unloaded. Conversely, if the data characteristics were similar before and after the stop, the processor 120 may determine that the railcar 100 was not unloaded when it stopped.

For instance, the processor 120 may compare a series of data points of the proximity sensor taken as the railcar 100 moves along a track with historical data indicative of the parameters of the railcar (e.g., load state). The parameter of the railcar may be determined where the data points of the proximity sensor correspond with a historical dataset associated with a certain parameter. As one example, the proximity sensor is the magnetometer 134. As another example, the proximity sensor is the ultrasonic sensor 136 of the mobile asset monitoring apparatus 102 arranged to detect the distance from the ultrasonic sensor 136 to the earth (e.g., the ground and track, ties, etc. thereon) as shown in FIG. 1. Because the position of the ultrasonic sensor 136 relative to the track changes based on the load state of the railcar 100 (e.g., due to movement of the bolster 108 relative to the side frame 106), the sensor data indicating the distance to the ground from the ultrasonic sensor 136 may be used to determine the load state of the railcar 100. However, because the distance to the ground along the track is generally not constant and varies based on location (e.g., due to rocks, hills, change in grade around a bend, etc.), the processor 120 compares sensor data of the ultrasonic sensor 136 with historical data of the ultrasonic sensor taken along that same section of track to determine the load state of the railcar 100. For example, the processor 120 may compare the sensor data taken at particular locations with historical sensor data of the ultrasonic sensor 136 of those same locations and which is associated with the loaded state and/or the unloaded state of the railcar 100. Where the sensor data corresponds to the historical data associated with the loaded state, the processor 120 may determine the railcar 100 is in the loaded state. Where the sensor data corresponds to the historical data associated with the unloaded state, the processor 120 may determine the railcar 100 is in the unloaded state. As a further example, the processor 120 may utilize a machine learning model to compare the differences in ultrasonic sensor data gathered when the railcar 100 makes a first trip, e.g., along a section of track, between two locations with sensor data gathered when the railcar 100 makes a second trip (such as in an opposite direction) along the same section of track. The section of track may be, for example, at least 0.5 miles long, at least 1 mile long, at least 2 miles long, at least three miles long, at least 4 miles long, at least 5 miles long, at least 10 miles long, at least 15 miles long, or at least 20 miles long. For example, the section of track may be 30, 50, or 100 or more miles long.

The ultrasonic sensor data gathered during the first and second trips along the section of track function as digital fingerprints that correlate with a condition of the railcar 100. When the condition is different, such as loaded versus unloaded, the digital fingerprints of the ultrasonic data are different because the ultrasonic sensor 136 will generally be closer to the earth when the railcar 100 is loaded and will move differently with the bolster 108 due to the heavier, loaded body 109. The comparison of the ultrasonic data gathered during the first and second trips along the section of track can be supplemented with additional sensor data, such as accelerometer, acoustic, and/or strain sensor data, to provide additional layers of data for the digital fingerprints that can be compared by the machine learning algorithm.

While use the ultrasonic sensor 136 has been discussed by way of example, the other sensors 127 may similarly be used to determine the parameter of the railcar 100 when the railcar 100 is in motion. The processor 120 may also make a determination of the parameter of the railcar 100 based on sensor data of multiple sensors 127 (e.g., the magnetometer 134 and the ultrasonic sensor 136).

Furthermore, the processor 120 may utilize outputs from algorithms associated with movement of the railcar 100 as well as outputs from algorithms associated with the stationary railcar 100 to further improve the overall determination of the desired parameter. For example, the processor 120 may utilize an output from a first algorithm that examines sensor data gathered before and after the railcar 100 stopped and an output from a second algorithm that examined sensor data while the railcar 100 was stopped.

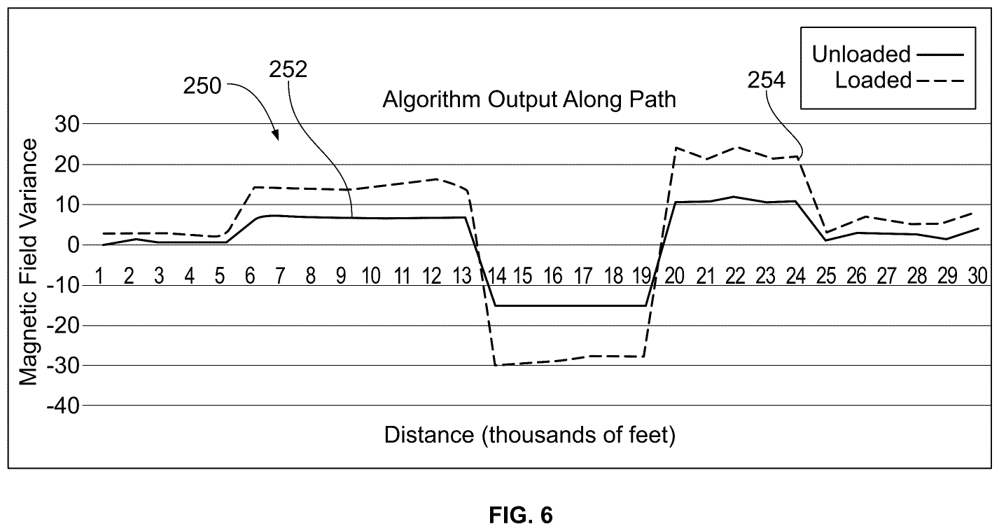

With reference to FIG. 6, a graph 250 is provided showing a magnetic field variance value calculated from sensor data of the magnetometer 132 as the railcar 100 travels along a particular stretch of track, from distance 1 to 30 (measured in thousands of feet). The data collected when the railcar 100 was in an unloaded state is shown with line 252. The data collected when the railcar 100 was in a loaded state is shown with line 254. Whereas FIG. 4 discussed above indicates that the magnetic field varies as the bolster 108 moves relative to the side frame 106 (e.g., due to a change in load state), FIG. 6 shows how the magnetic field varies as the railcar 100 moves along a track where the distance between the bolster 108 and side frame 106 remains substantially the same. The distance between the bolster 108 and side frame 106 remains substantially the same throughout each of the trips represented by lines 252, 254 because the railcar 100 remains loaded or unloaded throughout the entirety of each trip.

As shown, the line 252 of the unloaded state has different characteristics than the line 254 of the loaded state (where the side frame 106 is further from the bolster 108 than in the unloaded state). For example, when in the loaded state of line 254, the magnetic field variance value (calculated using data from multiple axes of a magnetometer) shifts more abruptly and to a greater degree than when in the unloaded state of line 252 as the railcar 100 travels along the same section of track. As examples, the change in magnetic field as the railcar 100 moves along the track may be caused by a change in orientation of the railcar 100 relative to the earth's magnetic field (e.g., a change from north to east) or a change in the environment (e.g., the railcar 100 passes over a steel bridge). The changes in magnetic field differ in each state (e.g., loaded versus unloaded) due to the difference in position of the side frame 106 relative to the bolster 108 and the effect this position has on the magnetic field as discussed above.

The processor may compare sensor data of the magnetometer 132 to historical data of known load states to determine the load state of the railcar 100. The mobile railway asset monitoring apparatus 102 (or the associated remote computer 125) may store data collected by the magnetometer 132 as the railcar 100 travels along the track along with location, speed, and/or orientation data so that the mobile railway asset monitoring apparatus 102 and/or remote computer 125 may compare magnetometer data with the stored data when the railcar 100 later travels along the same section of track to determine the parameter (e.g., load state) of the railcar 100. The processor 120 may similarly compare sensor data of the other sensors 127, such as the ultrasonic sensor 136 measuring the distance to the ground, to historical data of known load states to determine the load state of the railcar 100.

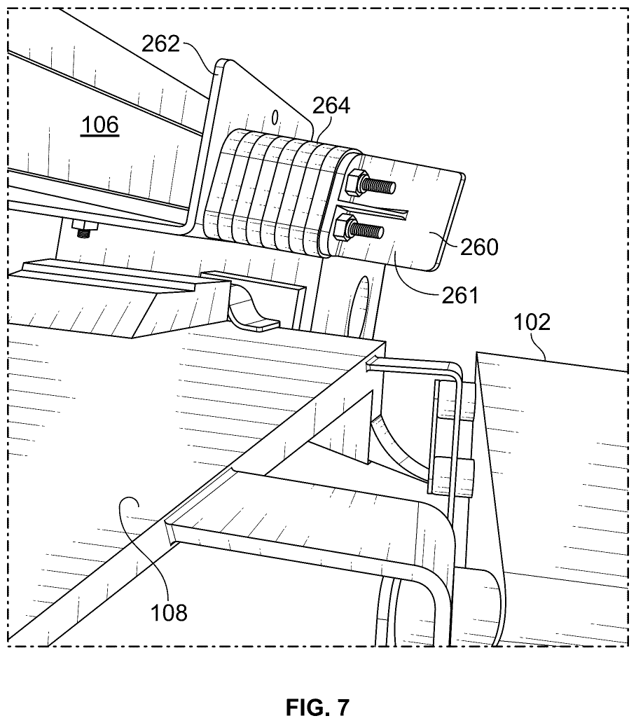

With reference to FIG. 7, the mobile railway asset monitoring apparatus may be used in conjunction with a magnetic field influencer 260 mounted to a component of the railcar 100 to change the magnetic field detected at the magnetometer 132 as the component moves relative to the magnetometer 132. The magnetic field influencer 260 may include a magnetic field disrupter such as a ferromagnetic material (e.g., a block of ferrous material, such as iron) that changes the magnitude and/or direction of the magnetic field produced by the earth and detected by the magnetometer 132. Alternatively or additionally, the magnetic field influencer 260 may include a magnet that changes, such as shifts, the magnetic field.

In the embodiment of FIG. 7, the magnetic field influencer 260 is rigidly coupled (e.g., by fasteners or welds) to the side frame 106 with a bracket 262 such that the magnetic field influencer 260 moves with the side frame 106 relative to the bolster 108. The magnetic field influencer 260 increases the change in the magnetic field detected by the magnetometer 132 as the side frame 106 moves relative to the bolster 108, making relative movement of the side frame 106 and bolster 108 easier to detect. The magnetic field influencer 260 may also be mounted to the side frame 106 to be closer to the magnetometer 132 to further increase the change in the magnetic field detected by the magnetometer 132 and caused by movement of the magnetic field influencer 260. In one embodiment, the magnetic field influencer 260 includes a magnet 261 supported on the mounting bracket 262 by a plurality of spacers 264 to position the magnetic field influencer 260 closer to the mobile railway asset monitoring apparatus 102. Increasing the change in the magnetic field increases the signal-to-noise ratio of the sensor data of the magnetometer 132 in detecting movement of the side frame 106, which increases the accuracy in detecting relative movement of the side frame 106. In other embodiments, the magnetic field influencer 260 may be mounted to non-ferrous components of the railcar 100 to enable the motion of such components to be detected by the magnetometer 132.

In some embodiments, the sensor data of the magnetometer 132 of the mobile railway asset monitoring apparatus 102 may be used to measure the rotational speed of the wheels of the wheelset 112 and/or the speed of the railcar 100. The wheelset 112 includes a magnet 112A (see FIG. 1) mounted to the wheels or axle such that the magnet rotates with the wheelset 112 as the railcar 100 moves along a track. For example, the magnet 112A may be mounted within an endcap of a spindle of the wheelset 112. The mobile railway asset monitoring apparatus 102 is mounted to the railcar 100 proximate the wheelset 112 such that the magnetometer 132 detects the changing magnetic field caused by rotation of the magnet of the wheelset 112. The processor 120 may determine the rotational speed of the wheelset 112 based upon the detected change in the magnetic field caused by the magnet rotating with the wheelset, e.g., by detecting the time it takes for the magnet to make a full revolution. The processor 120 may also determine the speed of the railcar 100, for example, based upon the detected rotational speed of the wheelset 112 and the running diameter of the wheels.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. A mobile railway asset monitoring apparatus comprising:
a magnetometer configured to detect a magnetic field produced by the earth and influenced by components of the mobile railway asset;
the magnetometer operable to detect a change in the magnetic field caused by relative movement of the components of the mobile railway asset; and
a processor operatively connected to the magnetometer and configured to determine a parameter of the mobile railway asset based at least in part upon the change in the magnetic field caused by the relative movement of the components.

2. The mobile railway asset monitoring apparatus of claim 1 wherein the processor is configured to calculate a soft iron offset associated with the effect of the components of the mobile railway asset on the magnetic field produced by the earth and detected by the magnetometer.

3. The mobile railway asset monitoring apparatus of claim 1 wherein the processor is configured to calculate a hard iron offset associated with the effect of the components of the mobile railway asset on the magnetic field produced by the earth and detected by the magnetometer.

4. The mobile railway asset monitoring apparatus of claim 1 wherein the processor is configured to receive data indicative of whether the mobile railway asset is stationary;
wherein the magnetometer is operable to detect the change in the magnetic field caused by the relative movement of the components of the mobile railway asset when the mobile railway asset is stationary; and
wherein the processor is configured to determine the parameter of the mobile railway asset based at least in part upon the change in the magnetic field caused by the relative movement of the components of the stationary mobile railway asset.

5. The mobile railway asset monitoring apparatus of claim 1 wherein the processor is configured to receive data indicative of the mobile railway asset moving at a first time and a second time;
wherein the magnetometer is operable to detect the change in the magnetic field based upon a difference between the magnetic field detected when the mobile railway asset is moving at the first time and when the mobile railway asset is moving at the second time; and
wherein the processor is configured to determine the parameter of the mobile railway asset based at least in part upon the change in the magnetic field caused by the relative movement of the components of the mobile railway asset between the first time and the second time.

6. The mobile railway asset monitoring apparatus of claim 1 wherein the magnetometer is operable to detect the change in the magnetic field caused by the relative movement of the components of the mobile railway asset when the mobile railway asset is moving and when the mobile railway asset is stationary; and
wherein the processor is configured to determine the parameter of the mobile railway asset based at least in part upon the change in the magnetic field caused by the relative movement of the components and whether the change in the magnetic field was detected by the magnetometer when the mobile railway asset was moving, stationary, or both.

7. The mobile railway asset monitoring apparatus of claim 1 wherein the processor is configured to receive data indicative of at least one of location and orientation of the mobile railway asset; and
wherein the processor is configured to determine the parameter of the mobile railway asset based at least in part upon the change in the magnetic field and the data.

8. The mobile railway asset monitoring apparatus of claim 1 wherein the magnetometer is configured to detect the change in the magnetic field by detecting a change in at least one of a magnitude and a direction of the magnetic field produced by the earth and detected by the magnetometer.

9. The mobile railway asset monitoring apparatus of claim 1 wherein the processor is configured to receive GNSS data associated with movement of the mobile railway asset; and
wherein the processor is configured to calculate a soft iron offset for the components based at least in part upon the detected magnetic field and the GNSS data.

10. The mobile railway asset monitoring apparatus of claim 1 wherein the magnetometer comprises a compass.

11. The mobile railway asset monitoring apparatus of claim 1 wherein the magnetometer comprises a three axis magnetometer.

12. The mobile railway asset monitoring apparatus of claim 1 wherein the parameter is indicative of a position of at least one of the components of the mobile railway asset.

13. The mobile railway asset monitoring apparatus of claim 1 wherein the parameter is indicative of at least one of:
a load state of the mobile railway asset;
a change in position of a hand brake component;
movement of a brake rigging component;
movement of a hatch cover;
movement of a coupler component;
movement of a gate component;
movement of a valve component;
raising of a portion of the mobile railway asset; and
tilt of a component of the mobile railway asset.

14. The mobile railway asset monitoring apparatus of claim 1 further comprising a magnetic field disruptor configured to be mounted to one of the components of the mobile railway asset; and
wherein the magnetometer is configured to detect the change in the magnetic field caused by movement of the magnetic field disruptor relative to the magnetometer.

15. The mobile railway asset monitoring apparatus of claim 1 further comprising a magnet to be mounted to one of the components of the mobile railway asset; and
wherein the magnetometer is configured to detect the change in the magnetic field caused by movement of the magnet relative to the magnetometer.

16. The mobile railway asset monitoring apparatus of claim 1 wherein the parameter comprises a speed of the mobile railway asset.

17. The mobile railway asset monitoring apparatus of claim 16 further comprising a magnet to be mounted to a wheelset of the mobile railway asset and rotate therewith; and
wherein the processor is configured to determine the speed of the mobile railway asset based at least in part upon the magnet rotating with the wheelset and changing the magnetic field.

18. The mobile railway asset monitoring apparatus of claim 1 further comprising a body, the magnetometer disposed in the body; and
wherein the body is configured to be secured to a bolster of the mobile railway asset.

19. The mobile railway asset monitoring apparatus of claim 1 further comprising:
communication circuitry operatively connected to the processor and operable to wirelessly communicate data associated with the parameter to a remote device;
a body to be mounted to the mobile railway asset; and
wherein the magnetometer, processor, and communication circuitry are in the body.

20. The mobile railway asset monitoring apparatus of claim 1 further comprising a body configured to be mounted to the mobile railway asset;
communication circuitry operatively connected to the magnetometer, the communication circuitry operable to communicate data indicative of the change in the magnetic field caused by the relative movement of the components to the processor via a wireless network; and
wherein the magnetometer and the communication circuitry are in the body.

21. A method of monitoring a mobile railway asset, the method comprising:
detecting, via a magnetometer, a magnetic field produced by the earth and influenced by components of the mobile railway asset; and
determining a parameter of the mobile railway asset based at least in part upon a change in the magnetic field caused by relative movement of the components.

22. The method of claim 21 wherein determining the parameter of the mobile railway asset comprises calculating a soft iron offset associated with an effect of the components of the mobile railway asset on the magnetic field produced by the earth and detected by the magnetometer.

23. The method of claim 21 wherein determining the parameter of the mobile railway asset comprises calculating a hard iron offset associated with the effect of the components of the mobile railway asset on the magnetic field produced by the earth and detected by the magnetometer.

24. The method of claim 21 further comprising determining whether the mobile railway asset is stationary;
wherein detecting the magnetic field comprises detecting the magnetic field when the mobile railway asset is stationary; and
wherein determining the parameter of the mobile railway asset comprises determining the parameter based at least in part upon the change in the magnetic field caused by the relative movement of the components of the stationary mobile railway asset.

25. The method of claim 21 wherein detecting the magnetic field comprises detecting the magnetic field when the mobile railway asset is moving at a first time and detecting the magnetic field when the mobile railway asset is moving at a second time; and
wherein determining the parameter of the mobile railway asset comprises determining the parameter based at least in part upon the change in the magnetic field caused by the relative movement of the components between the first time and the second time.

26. The method of claim 21 wherein detecting the magnetic field comprises detecting the magnetic field when the mobile railway asset is stationary and detecting the magnetic field when the mobile railway asset is moving; and
wherein determining the parameter of the mobile railway asset comprises determining the parameter based at least in part upon the change in the magnetic field detected when the mobile railway asset was stationary, moving, or both.

27. The method of claim 21 wherein determining the parameter of the mobile railway asset comprises determining the parameter of the mobile railway asset based at least in part upon:
the change in the magnetic field caused by the relative movement of the components; and
at least one of a location and an orientation of the mobile railway asset.

28. The method of claim 21 wherein the parameter is indicative of at least one of:
a load state of the mobile railway asset;
a change in position of a hand brake component;
movement of a brake rigging component;
movement of a hatch cover;
movement of a coupler component;
movement of a gate component;
movement of a valve component;
raising of a portion of the mobile railway asset; and
tilt of a component of the mobile railway asset.

29. The method of claim 21 further comprising determining an orientation of the mobile railway asset relative to the earth based at least in part upon data from the magnetometer.

30-60. (canceled)
